(19) United States
(12) Patent Application Publication
(10) Pub. No.: US 2017/0241773 A1
(43) Pub. Date: Aug. 24, 2017

(54) SURFACE SHAPE MEASURING APPARATUS AND DEFECT DETERMINING APPARATUS

(71) Applicant: CANON KABUSHIKI KAISHA, Tokyo (JP)

(72) Inventor: Masayuki Nishiwaki, Yoshikawa-shi (JP)

(21) Appl. No.: 15/519,772

(22) PCT Filed: Dec. 14, 2015
(86) PCT No.: PCT/JP2015/085433

§ 371 Date: Apr. 17, 2017

(30) Foreign Application Priority Data
Dec. 16, 2014 (JP) 2014-254579
Dec. 3, 2015 (JP) 2015-236519

(51) Int. Cl. G01B 11/24; G01N 21/952

(52) U.S. Cl. CPC G01B 11/2408; G01N 21/952; G01N 2201/08; G01N 2201/1053; G01N 2201/06113

(57) ABSTRACT

A detecting unit 4 receives light reflected from the object 2. A detecting unit 4 has a plurality of light guiding members 404 and 405 adjacently arranged so that longitudinal surfaces thereof are arranged along a longitudinal direction of the object 2, and photo sensors 410 and 411 which receive rays that are incident from the longitudinal surfaces constituting a light incident surface of each of the light guiding members and are emitted from light emitting surfaces of the light guiding members. An image forming device 3 forms an image of the reflected light, on the vicinity of the light incident surface. The surface shape of the object 2 in a portion in which the reflected light has been reflected is measured according to an output distribution of each of the photo sensors 410 and 411 arranged to face the light emitting surfaces.

### TECHNICAL FIELD

The present invention relates to a surface shape measuring apparatus which illuminates an object and measures the shape of the object through an output of a photo sensor that receives the reflected light that has been reflected on a surface to be measured of the object; and a defect determining apparatus which determines a defect according to the measurement result of this surface shape measuring apparatus.

### BACKGROUND ART

Conventionally, various techniques for optically measuring the surface shape of the object are known, for the purpose of surface defect inspection and the like. For instance, a technique of irradiating the object with illumination light, catching the reflected light with a camera and detecting a defect is one of the techniques. In recent years, a digital camera becomes widely available, and for instance, a camera photography type of measurement of a surface shape is used in various scenes, which is compatible with image data analysis.

On the other hand, there is also such a technique other than the camera technology, for instance, as to use a laser as a light source, scan the surface of the object with a polariscope and detect a surface detect from the reflected light. In this technique, the surface of the object is scanned with laser illumination light, the reflected light is received by a light guiding member, and the defect is detected (for instance, PTL 1 described below). In PTL 1, such a technique is described as to fetch an output from a photo sensor which is arranged in an end of the light guiding member, in synchronization with scan with illumination light, or further generate measurement data that corresponds to a two-dimensional surface shape of the object, from the output of the photo sensor, which corresponds to a plurality of lines that have been scanned with the illumination light.

In addition, when the surface shape of the object is different from others, the direction of reflected light changes which has been reflected in the portion. By utilizing this phenomenon, such a technique is also considered, for instance, to utilize the direction of the light reflected from a spot of laser illumination light, as a measurement output corresponding to the surface shape. In order to detect the imaging or irradiation position of the reflected light, a photo sensor device such as a so-called split PD (photodiode) can be utilized. In a light-receiving system using one split PD, the deviation of the one-dimensional imaging or irradiation position of target light can be measured. In addition, such a technique is also known as to detect the two-dimensional imaging or irradiation position of the target light, with the use of a quadrisectioned sensor (for instance, PTL 2 described below). The configuration of the quadrisectioned sensor in PTL 2 is used for detecting a change of a distance between the sensor and the object.

### CITATION LIST

### Patent Literature

PTL 1: Japanese Patent Application Laid-Open No. H06-294758

PTL 2: Japanese Patent Application Laid-Open No. S63-196807

### SUMMARY OF INVENTION

### Technical Problem

In the case where a defect of a component, for instance, is detected by utilizing optical surface shape measurement, all the surface defects of the object are not a defect which has such a clear contrast as to be capable of being detected by a digital camera. There also exists a surface defect which resists being detected as a change of the contrast by the digital camera, for instance, like a small change of the shape on the surface. This type of the surface defect can be detected by a special arrangement of a camera and illumination, in some cases, but usually, the angle of the illumination and the position of the camera need to be adjusted every time, and it is difficult to automatically measure the surface defect. In addition, in the case or the like, for instance, where the surface properties of the object, in addition to the shape, change depending on the portions, it is difficult, for instance, to separate a change originating in the shape and a change originating in the surface properties from the contrast change in image data, and it is very difficult to stably detect the defect.

In addition, the small change of the shape on the surface affects the function of a product in many cases. When considering from the control of the product, not only the surface shape is detected but also the shape must be quantified. In addition, it is also required from a production side to shorten a time period during which one component is inspected. For this purpose, it is an indispensable content to expand the inspection range.

In the viewpoint of expanding the measurement range, the technology disclosed in PTL 1 is comparatively easy. The technology copes with the expansion of the measurement range only by expanding a scanning section, and extending a light guiding member. However, this method may detect the change of the shape, but has such a problem that it is difficult to quantitatively grasp the change of the shape.

There is a method of grasping the form of the reflected light by processing an output of the quadrisectioned sensor, as is shown in PTL 2. However, in the configuration of PTL 2, it is required that optical axes of an illumination optical system and a light-receiving system are coaxial. The case is also considered where it is difficult to arrange the optical axis of the light-receiving system coaxially with the optical axis of the illumination optical system, depending on the shape of the object.

With respect to the above description, a subject of the present invention is to enable a fine surface shape of an object to be surely measured with the use of a photo sensor having a simple and inexpensive configuration, and enable a defect of the object to be measured with high reliability according to the measured surface shape.

### Solution to Problem

According to an aspect of the present invention, a surface shape measuring apparatus which illuminates an object and measures a shape of the object through an output of a photo sensor that receives reflected light that has been reflected on a surface to be measured of the object, comprises: a light receiving unit provided with a plurality of light guiding members which are adjacently arranged so that longitudinal surfaces thereof are arranged along a longitudinal direction of the object, and photo sensors that receive rays which are incident from the longitudinal surfaces that constitute a light incident surface of each of the light guiding members and are emitted from light emitting surfaces of the light guiding members; and an image forming device which images the reflected light from the object, on a vicinity of the light incident surface of the light receiving unit, the surface shape measuring apparatus measuring a surface shape of the object in a portion on which the reflected light has been reflected, according to an output distribution of each of the photo sensors which are arranged so as to face the light emitting surfaces of each of the light guiding members, respectively.

Further features of the present invention will become apparent from the following description of exemplary embodiments with reference to the attached drawings.

### BRIEF DESCRIPTION OF DRAWINGS

FIG. 1 is a perspective view illustrating a whole configuration of a surface shape measuring apparatus, and a defect determining section utilizing this surface shape measuring apparatus, in Example 1 of the present invention.

FIG. 2 is an explanatory view illustrating a configuration of a scan unit in FIG. 1.

FIG. 3 is a sectional view illustrating a configuration of a detecting unit in FIG. 1.

FIG. 4 is an explanatory view illustrating a light incident surface (lower surface) of the reflected light of the detecting unit in FIG. 1.

FIGS. 5A and 5B illustrate the configurations of the detecting unit in FIG. 1; FIG. 5A is an explanatory view in which the portion A in FIG. 4 has been enlarged; and FIG. 5B is a sectional view taken along the line 5B-5B in FIG. 5A.

FIG. 6 is an explanatory view illustrating a state in which reflected light has been incident on the detecting unit in FIG. 1.

FIG. 7 is an explanatory view illustrating outputs from a photo sensor of the detecting unit in FIG. 1.

FIG. 8 is a perspective view illustrating a whole configuration of a surface shape measuring apparatus, and a defect determining apparatus utilizing this surface shape measuring apparatus, in Example 2 of the present invention.

FIGS. 9A, 9B and 9C illustrate configurations of a detecting unit in FIG. 8; FIG. 9A is an explanatory view of the detecting unit illustrated from an X-direction; FIG. 9B is an explanatory view of the detecting unit illustrated from a Y-direction; and FIG. 9C is an explanatory view of the detecting unit illustrated from a Z-direction.

FIG. 10 illustrates a specific configuration of a surface shape measuring apparatus in Example 3.

FIGS. 11A, 11B and 11C illustrate a configuration of a detecting unit of the surface shape measuring apparatus in Example 3.

FIG. 12 illustrates a state of the refraction of light which is reflected light from an object and is vertically incident on an optical member.

FIG. 13 illustrates a specific configuration of a surface shape measuring apparatus in Example 4.

FIG. 14 illustrates a configuration of a detecting unit of the surface shape measuring apparatus in Example 4.

FIGS. 15A, 15B and 15C illustrate light guiding members 041 and 042, and a lens system 3.

FIG. 16 illustrates a specific configuration of a surface shape measuring apparatus in Example 5.

### DESCRIPTION OF EMBODIMENTS

The mode for carrying out the present invention will be described below with reference to examples illustrated in the attached drawings. Incidentally, the examples which will be described below are just a few examples, and those skilled in the art can appropriately modify, for instance, a detailed configuration, in such a range as not to deviate from the spirit of the present invention. In addition, numeric values taken up in the present embodiment are reference numeric values, and do not limit the present invention.

### Example 1

### (Configuration of Hardware)

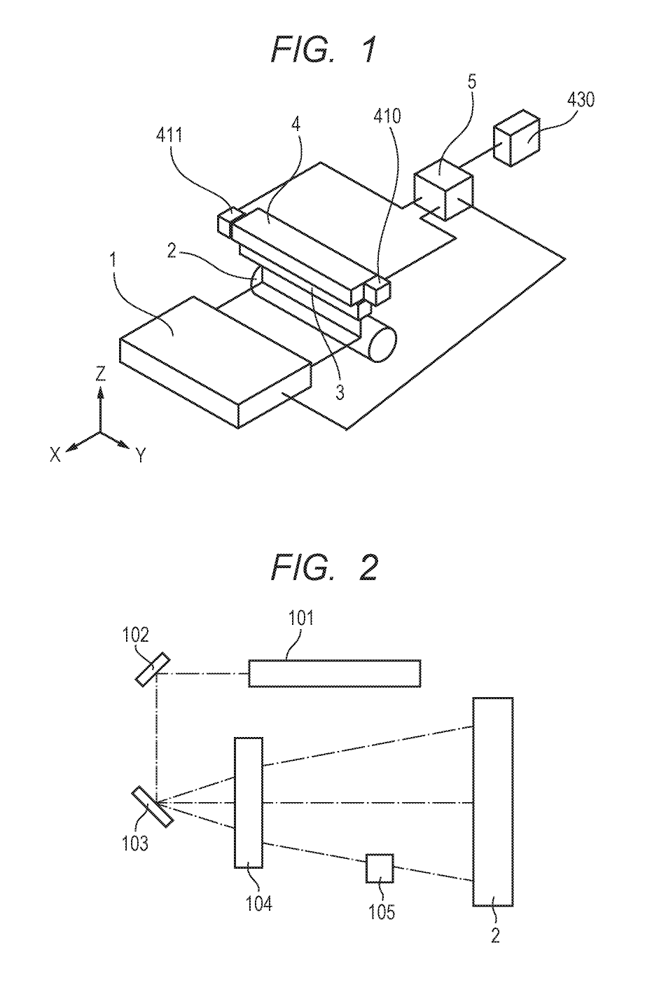

FIG. 1 illustrates a whole configuration of a surface shape measuring apparatus (and defect determining apparatus utilizing this surface shape measuring apparatus) in the present Example. In FIG. 1, a three-dimensional coordinate of X, Y and Z is illustrated, and in the followings, the present invention will be described with the use of this coordinate system, as needed.

An object 2 which is an object to be measured by the surface shape measuring apparatus in FIG. 1 has a cylindrical shape. The object 2 is arranged so that a direction of the ridge line thereof (longitudinal direction) coincides with a scanning direction of scanning illumination light of a scan unit 1 which will be described later, and with a longitudinal direction of light guiding members 404 and 405 of a detecting unit 4 (light receiving unit) which will be described later. In addition, in the coordinate system in FIG. 1, the above described scanning direction and each of the longitudinal directions are determined so as to be approximately in parallel to the Y axis.

The object 2 is assumed to be a conveying roller or the like which is used, for instance, in a printer and the like, but the object 2 does not necessarily need to have a cylindrical shape. A length (whole length) in a Y-direction of the object 2 shall be in a range of several cm to 10-odd cm to several tens cm, for instance. In this case, in order to inspect the whole length of the object 2, the length in the Y-direction of the detecting unit 4 (light receiving unit), particularly, of the light guiding members 404 and 405 is configured so as to be approximately equal to or larger than the whole length of the object 2.

The surface shape measuring apparatus in FIG. 1 has an illumination light scanning unit, for instance, a scan unit 1 utilizing a galvanometer mirror as illustrated in FIG. 2. This scan unit 1 irradiates the object 2 with laser light, and illuminates the object 2. Reflected light of the illumination light which has scanned a surface to be measured of the object 2 in the longitudinal direction is incident on the detecting unit 4 (light receiving unit).

FIG. 2 illustrates a configuration example of the scan unit 1. In FIG. 2, the scan unit 1 is structured of members other than the object 2. As is illustrated, the laser light is emitted from a light source 101 (semiconductor laser element and the like) which is arranged in the scan unit 1, is reflected by a mirror 102, and is incident on a deflector 103. The dashed-dotted line in FIG. 2 illustrates an optical path of a laser beam.

The deflector 103 is structured of an optical deflection system, for instance, using the galvanometer mirror as described below. For instance, the deflector 103 is structured of a reflecting mirror (galvanometer mirror) which is driven by a galvanometer motor. The reflecting surface of the reflecting mirror (galvanometer mirror) is mounted on a rotary shaft of the galvanometer motor (not illustrated). A sinusoidal signal is given to this motor, and thereby the reflecting mirror (galvanometer mirror) vibrates which constitutes the deflector 103. The laser light which has been reflected by the deflector 103 is imaged on the surface of the object 2 through a lens 104.

The spot of the laser light, which has been imaged on the surface of the object 2, is linearly scanned in the ridge line direction (longitudinal direction) of the object 2, by the movement of the deflector 103. In addition, a photo sensor 105 is provided in the scan unit 1. This photo sensor 105 is arranged, for instance, in a position at which the photo sensor can detect a head of one line of the laser light scanned by the deflector 103. The surface shape measurement processing in a measurement arithmetic section 5 which will be described later can perform line synchronization by using an output signal of the photo sensor 105.

The surface shape measuring apparatus rotationally drives the object 2 having the cylindrical shape by an unillustrated driving system very little by little, for instance, in synchronization with the line scan by the laser illumination light of the above described scan unit 1, and repeats surface shape measurement on each of the lines scanned with the illumination light, which will be described later. Thereby, the surface shape can be measured over the whole perimeter of the object 2. If the scanning time period by the scan unit 1 and the rotationally driving speed of the object 2 are set, the change of the surface shape of the whole object 2 can be measured at high speed.

Incidentally, the scan unit 1 may employ not only the above described galvanometer deflection system but also an arbitrary configuration, as long as the scan unit 1 is an illumination light scanning unit which illuminates the surface of the object 2 with punctiform illumination having a size of which the light can be regarded as a spot, and can give the change of the position with time. For instance, a polygon mirror which has a reflecting surface arranged in a polygon form and is rotationally driven by a motor or the like may be used for the deflector 103, in place of the galvanometer mirror. In addition, an LED array (LED printer head) is arranged behind the lens 104, and LEDs in the LED array are sequentially made to emit light one by one in the line direction, or a plurality of LED light-emitting elements corresponding to a size which can be regarded as the same spot are sequentially and simultaneously made to emit light in the line direction. By such configurations as well, the illumination light scanning unit similar to the above description can be configured.

In FIG. 1 again, the object 2 is illuminated with the scanning illumination light of the above described scan unit 1. The detecting unit 4 (light receiving unit) is arranged so as to receive reflected light having an angle of approximately 90° with respect to the scanning illumination light, among the reflected light from the object 2, which have been generated by the illumination of the scan unit 1. Incidentally, the angle between the scanning illumination light and the reflected light which is received by the detecting unit 4 is not limited to the above described 90°. The detecting unit (light receiving unit) may be arranged so as to detect reflected light having an arbitrary reflecting angle with respect to the scanning illumination light, as long as the detecting unit 4 is in a state of being capable of detecting the quantity of the reflected light, on which the surface shape measurement that will be described later can be sufficiently performed. Incidentally, “state of being capable of detecting quantity of reflected light” means, for instance, a state in which the detecting unit 4 can discriminate the reflected light from the object 2, compared to noises that are generated by the photo sensors 410 and 411 therein which will be described later. When a signal strength of the photo sensors 410 and 411 is represented by S, and a signal strength of the noise is represented by N, for instance, the above described state is a state in which the ratio S/N is 1 or more.

The reflected light from the object 2 is incident on the light receiving surface (light incident surface) of the detecting unit 4 (light receiving unit) through an image forming device 3. The image forming device 3 forms the image of the reflected light from the object 2, on the vicinity of the light receiving surface (light incident surface) of the detecting unit 4 (light receiving unit).

For instance, a microlens array (for instance, SELFOC (registered trademark) lens or the like) can be used for the image forming device 3. The microlens array is a lens array in which miniature (micro) lenses that are gradient index lenses are linearly aligned. When the microlens array is used, each of the lenses in the microlens array of the image forming device 3 is arranged so as to face the direction of the light receiving surface of the detecting unit 4 (light receiving unit), as a matter of course.

Incidentally, a cylindrical (cylinder) lens can also be used for the image forming device 3. When the cylindrical (cylinder) lens is used, the optical surface having the cylindrical shape is arranged so that the reflected light from the object 2 forms the image on the vicinity of the light receiving surface of the detecting unit 4 (light receiving unit). In this case, the optical surface having the cylindrical shape of the cylindrical lens shall be arranged so as to be approximately in parallel to the light incident surface (lower surface of detecting unit 4 in FIG. 1) of the detecting unit 4 (light guiding members 404 and 405 thereof), for instance.

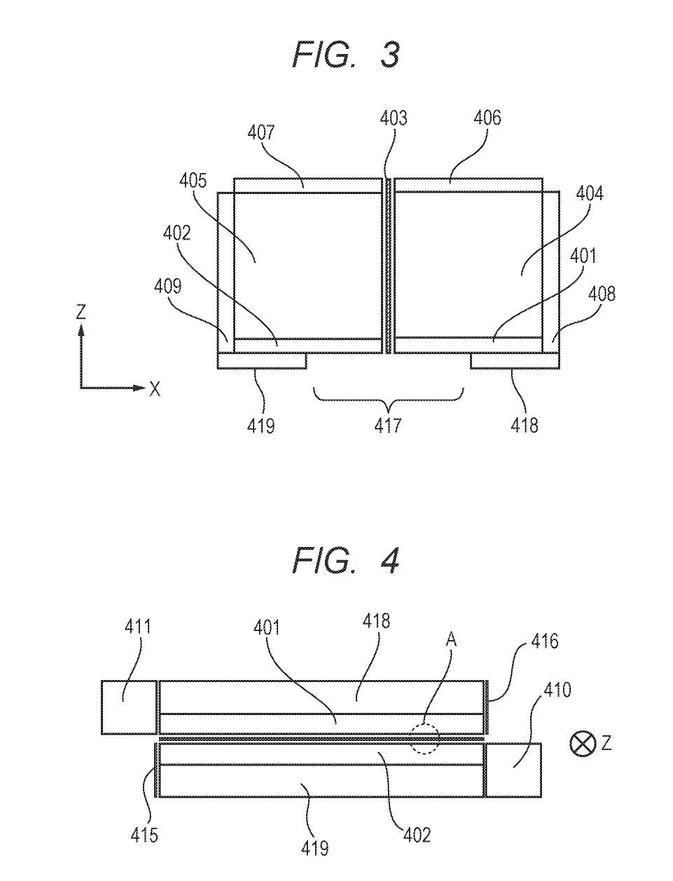

In FIG. 1, the reflected light from the object 2 is reflected to the Z-direction, and accordingly the light incident surface of the detecting unit 4 is arranged downward in FIG. 1. The detecting unit 4 has a basic configuration formed of the two light guiding members 404 and 405 (FIG. 3) and the photo sensors 410 and 411 arranged in each of the ends of these light guiding members, as is described below.

As for more details, the detecting unit 4 is arranged so that a straight line of dividing the light incident surface into the light guiding members 404 and 405 is in parallel to the Y axis in FIG. 1, and also is in parallel to the scanning line on the object 2 by the illumination light of the scan unit 1. The direction in which the image forming device 3 is arranged is also similar, and is arranged so as to be in parallel to the scanning line on the object 2 by the illumination light of the scan unit 1. Each of the optical axes of the microlenses of the image forming device 3, in particular, is set in such a direction as to connect the scanning line on the object 2 by the illumination light of the scan unit 1, with the straight line which divides the above described detecting unit 4 into the light guiding members 404 and 405. One of the arrangements which satisfy the condition as described above is, for instance, an arrangement in which the image forming device 3 and the straight line of dividing the light guiding members 404 and 405 are arranged right above the scanning line on the object 2 by the illumination light in the Z-direction, and in parallel to the scanning line by the illumination light, and each of the optical axes of the image forming device 3 is set toward the Z-direction (upward).

The detection rays which have been incident on the detecting unit 4 are repeatedly reflected in the inside of the light guiding members 404 and 405, and are incident on the photo sensors 410 and 411, respectively. The outputs of the photo sensors 410 and 411 are input into the measurement arithmetic section 5. The measurement arithmetic section 5 converts the analog signal into a digital signal, captures the converted signal as the digital data, and performs the surface shape measurement processing according to the distribution of the outputs of the photo sensors 410 and 411.

In addition, the defect of the object 2 can also be determined according to the surface shape measurement result of the measurement arithmetic section 5. In FIG. 1, the defect determining section 430 is illustrated as a unit for utilizing the surface shape measurement result of the measurement arithmetic section 5. The defect determination which is performed by the defect determining section 430 will be described later.

FIG. 3 and FIG. 4 illustrate the configuration of the detecting unit 4 in more detail. FIG. 3 illustrates a cross section (in parallel to XZ plane in FIG. 1) of the detecting unit 4, and FIG. 4 illustrates the light incident surface (lower surface) of the detecting unit 4, respectively.

The detecting unit 4 has the plurality of light guiding members 404 and 405 which are adjacently arranged so that the longitudinal surfaces (light incident surfaces) of the lower surfaces are arranged along the longitudinal direction of the object 2. The light guiding members 404 and 405 are formed into a rectangular shape with the use of, for instance, a transparent material having high optical transparency, for instance, an acrylic, various optical glasses and the like. In the present example, the material of the light guiding members 404 and 405 is assumed to be the acrylic.

In the present example, lateral surfaces of the light guiding members 404 and 405 are used as the light emitting surface, and accordingly the photo sensors 410 and 411 are arranged so as to face the lateral surfaces of the light guiding members 404 and 405, respectively. The photo sensors 410 and 411 receive rays which are incident from the longitudinal surfaces of the light guiding members 404 and 405 and are emitted from these light emitting surfaces.

The light guiding members 404 and 405 shall have such a size that the length in the cross section (in Z-direction in FIG. 1 and FIG. 3) between the longitudinal surface that constitutes the light incident surface and an opposite surface on which diffusing plates 406 and 407 that will be described later are arranged is a level of at least 5 mm or more distant. In the light guiding members 404 and 405 having the whole length of the same level as that of the object 2 which has the above described whole length of, for instance, several cm to several tens cm, the length of the above described cross section can be set at approximately 5 mm to 10 mm, in consideration of an efficiency at which the light which has been incident on the central portion is transmitted to the photo sensors 410 and 411.

Furthermore, the detecting unit 4 can have the following configuration provided therein so as to enhance light transmission efficiency of the light guiding members 404 and 405. Specifically, the detecting unit 4 is provided with prism plates 401 and 402, a light shielding plate (light shielding member) 403, diffusing plates 406 and 407, and reflecting plates 408, 409, 415 and 416.

As is illustrated in FIG. 3, the prism plates 401 and 402 are plates for adjusting the direction of the light which has been incident on the light guiding members 404 and 405, repeats total reflection in the inner part and is transmitted, to suitable directions for the photo sensors 410 and 411 to receive the light. The prism plates 401 and 402 can be arranged so as to come in close contact with or be bonded to the lower surface (light incident surface) side of the light guiding members 404 and 405.

Incidentally, as is illustrated in FIG. 3, the lower edge portions in the outside of the prism plates 401 and 402 on the lower surface of the light guiding members 404 and 405 are covered with covers 418 and 419 so that only the central region at which the prism plates 401 and 402 are mutually adjacent is exposed as a substantial light incident portion 417 (opening). The inner surface of the covers 418 and 419 may be formed of the reflecting surface, similarly to the reflecting plates 408, 409, 415 and 416 which will be described later. In addition, the outer (lower) surface of the covers 418 and 419 may be submitted to mat black coating or the like so that unnecessary reflection is prevented.

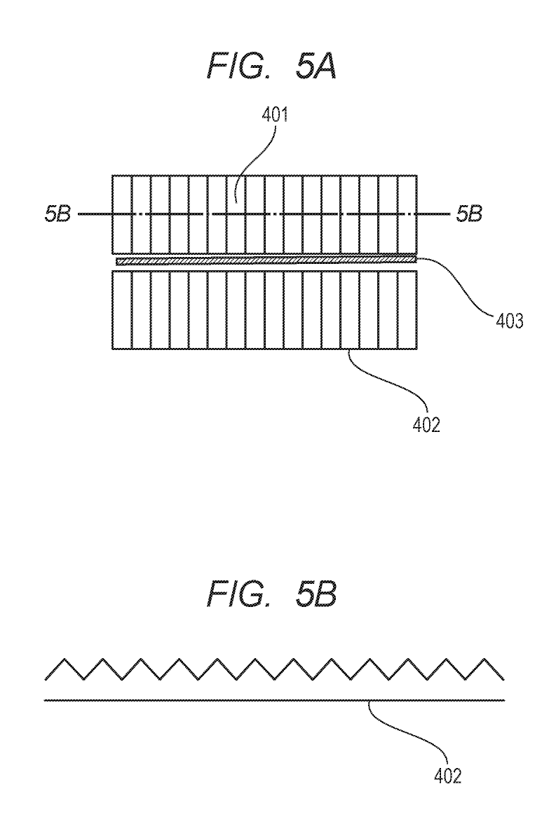

FIG. 5A illustrates the portion A in FIG. 4, which is enlarged in order to illustrate the function of the prism plates 401 and 402. As is illustrated in FIG. 5A, the prism plates 401 and 402 are optical members having prism structures, in which micro prisms are regularly arrayed in the Y-direction (horizontal direction in FIG. 5A). The prism plates 401 and 402 are formed of a material such as a resin (for instance, acrylic or the like), by injection molding or the like.

FIG. 5B illustrates the cross section of the prism plates 401 and 402 taken along the line 5B-5B in FIG. 5A. The micro prisms which constitute the prism plates 401 and 402 shall have such a shape as to repeat concave and convex, for instance, at approximately 90° as is illustrated in FIG. 5B. The width in the Y-direction (horizontal direction in FIG. 5B) of one micro prism which constitutes these prism plates 401 and 402 is set to be sufficiently smaller than the whole length (for instance, several cm to several tens cm in the above described example) of the light guiding members 404 and 405. In the present example, the width in Y-direction (horizontal direction in FIG. 5B) of one micro prism which constitutes these prism plates 401 and 402 is set, for instance, at approximately 0.01 mm.

The prism plates 401 and 402 and the light guiding members 404 and 405 can be arranged so that the plates come in close contact with the members, respectively. For instance, the prism plate 401 and the light guiding member 404, and the prism plate 402 and the light guiding member 405 are combined by bonding.

The reflected light from the object 2 receives a refractive action of these prism plates 401 and 402, and then is incident on the light guiding members 404 and 405. The reflected light from the object 2 theoretically has the incident angle in the Z-direction, but this incident angle is deflected to various directions by the prism plates 401 and 402. Thereby, the incident angles with respect to the total reflection interface of the light guiding members 404 and 405 become random, compared to the case where prism plates 401 and 402 do not exist, and the reflected light becomes efficiently transmitted to the direction of the lateral surfaces (end faces) of the light guiding members 404 and 405.

Incidentally, in the present invention, the micro prism structures of the prism plates 401 and 402 exist on the light incidence side (lower surface side in FIG. 1 and FIG. 3), but may also be formed on the light emission side, and may also be formed on both of the light incidence side and the light emission side. In addition, the prism plates 401 and 402 do not necessarily need to be arranged so as to come in close contact with the light guiding members 404 and 405, but may also be arranged so as to be separated to some extent.

The light shielding plate 403 is arranged in between the light guiding members 404 and 405, over the whole length of these light guiding members. The light shielding plate 403 functions as a light shielding member for shielding the rays so that the crosstalk of optical signals does not occur between the light guiding members 404 and 405. A thin metal plate, for instance, can be used for the light shielding plate 403, but basically, an arbitrary material can be used as long as the material is a light shielding material having a light transmittance of (approximately) 0. In addition, both surfaces of the light shielding plate 403 can be formed of the reflecting surface in a similar way to the reflecting plates 408, 409, 415 and 416 which will be described later, or also be a light diffusing surface such as the diffusing plates 406 and 407. Alternatively, both of the surfaces of the light shielding plate 403 may be coated with mat black coating or the like. Incidentally, the width of the light shielding plate 403 is desirably determined so that the side of the light guiding member 404 and the side of the light guiding member 405 are separated from each other, which include the diffusing plates 406 and 407 that will be described later.

As is illustrated in FIG. 3, the diffusing plates 406 and 407 are arranged on the longitudinal surface in an opposite side to the prism plates 401 and 402, of the light guiding members 404 and 405. The diffusing plates 406 and 407 are optical members having light diffusion characteristics. The diffusing plates 406 and 407 are formed of, for instance, a material having high light diffusibility such as a milky white acrylic plate, and formed by injection molding or the like. The arranged diffusing plates 406 and 407 suppress such unnecessary specular reflection light as to directly head for the direction of the object 2, for instance, from the upper inner surface of the light guiding members 404 and 405, and can increase components that head for the direction of the reflecting plates 408 and 409 (or 415 and 416) which will be described later.

Incidentally, the diffusing plates 406 and 407 are illustrated as members which are different from the light guiding members 404 and 405, but may be embedded in the light guiding members 404 and 405. The diffusing plates 406 and 407 can have such a configuration as to be integrated with the light guiding members 404 and 405 or brought into close contact with the light guiding members 404 and 405 by bonding, but may also be arranged so as to be separated from the light guiding members 404 and 405 to some extent. Alternatively, the upper surfaces of the light guiding members 404 and 405 may be submitted to aventurine working or blast working to have a light diffusing surface equivalent to the diffusing plates 406 and 407 formed thereon. In addition, a white paint having high light diffusibility may be applied directly onto the surface of the light guiding members 404 and 405, in place of the diffusing plates 406 and 407.

As has been described above, the arranged diffusing plates 406 and 407 suppress the specular reflection light which heads for the direction of the object 2 from the upper inner surface of the light guiding members 404 and 405, and can almost uniformly diffuse the light. On the other hand, in order to make a larger quantity of the light be incident on the photo sensors 410 and 411, it is necessary to return the light which has diffused in the diffusing plates 406 and 407, to the inside of the light guiding members 404 and 405 as much as possible. In addition, it is more desirable to make the light which results in being emitted to the outside of the light guiding members 404 and 405 while transmitting through the interfaces of the light guiding members 404 and 405, head for the inside of the light guiding members 404 and 405 again.

For this reason, in the present example, the reflecting plates 408, 409, 415 and 416 are arranged on interfaces except: the light incident surface (lower surface) of the light guiding members 404 and 405; opposite surfaces to the surfaces on which the diffusing plates 406 and 407 are arranged; and the light emitting surface on which the photo sensors 410 and 411 are arranged. The reflecting plates 408, 409, 415 and 416 are optical members having light reflection characteristics, and are formed of, for instance, a metal plate and a glass plate; and as a matter of course, at least the inner surface side thereof is submitted to specular working to be formed as a light reflecting surface.

Incidentally, the reflecting plates 408, 409, 415 and 416 may be arranged so as to be brought into close contact with or be separated from the light guiding members 404 and 405, similarly to the diffusing plates 406 and 407, or may also be formed integrally with the light guiding members 404 and 405. For instance, the reflecting surface equivalent to the reflecting plates 408, 409, 415 and 416 may be formed directly on the light guiding members 404 and 405 by specular working or the like.

When the reflecting plates 408, 409, 415 and 416 are thus arranged, these reflecting plates can reflect the light which has been diffused in the diffusing plates 406 and 407, and transmit the light to the direction of the photo sensors 410 and 411 without waste. In addition, the reflecting plates 408, 409, 415 and 416 reflect also the light having such an incident angle as to transmit through the interfaces of the light guiding members 404 and 405, and can transmit the light to the direction of the photo sensors 410 and 411 without waste.

### (Surface Shape Measurement)

Next, the surface shape measurement using the above described configuration will be described below.

As has been described above, the image forming device 3 is arranged so as to form an image of the (laser light) spot with which the scan unit 1 has irradiated the object 2, on the vicinity of the light receiving surface (light incident surface) of the detecting unit (light receiving unit). The reflected light which has been incident from the object 2 side repeats reflection and scattering in the inside of the light guiding members 404 and 405, and results in being incident on the photo sensors 410 and 411 that have been arranged on one end face of the light guiding members 404 and 405.

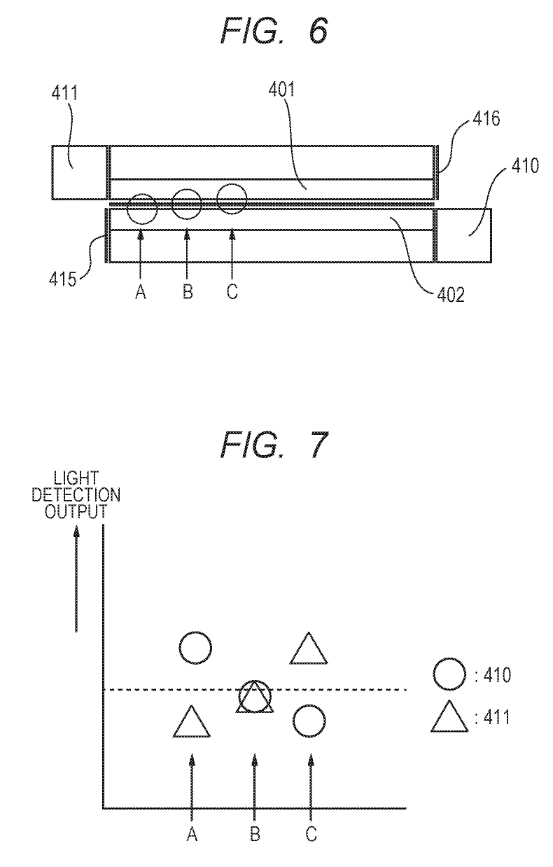

As has been described above, in the case where the image forming device 3 and the boundary between the light guiding members 404 and 405 are arranged right above the scanning line on the object 2 by the illumination light in the Z-direction, and in parallel to the scanning line by the illumination light, the image forming device 3 results in forming the spot image on the vicinity of the boundary between the light guiding members 404 and 405. In this case, as is illustrated by B in FIG. 6, the image forming device 3 results in forming the spot image on the vicinity of the boundary between the prism plates 401 and 402 (which are arranged below light guiding members 404 and 405, respectively). FIG. 6 illustrates the light receiving surface (light incident surface) of the detecting unit 4 (light receiving unit), from the lower surface side in an equivalent form to FIG. 4.

Here, if the strength distribution of the spot image formed by the image forming device 3 is, for instance, symmetric with respect to the boundary line between the light guiding members 404 and 405 as is illustrated by B in FIG. 6, rays having the same strength result in being incident on the light guiding members 404 and 405 and consequently on the photo sensors 410 and 411. In this case, the outputs of the photo sensors 410 and 411 theoretically become equal.

On the other hand, if there is a change of the shape, for instance, concave and convex in the X-axis direction on the surface of the object 2, the irradiation position on the object 2 changes on which the illumination light spot of the scan unit 1 is incident, and the position particularly in the X-axis direction changes. Correspondingly to this change, an imaging position at which the spot image of the illumination light is formed by the image forming device 3 changes in the X-axis direction in FIG. 1 and FIG. 3, and deviates to the light guiding member 404 side or the light guiding member 405 side, on the light incident surface of the detecting unit 4 functioning as the light receiving unit. When the position of the spot image of the illumination light thereby shifts on the light receiving surface (light incident surface) of the detecting unit 4 (light receiving unit), the quantity of the light changes which is incident on the prism plates 401 and 402 and on the light guiding members 404 and 405.

In the state of A in FIG. 6, for instance, the position of the spot image of the illumination light shifts toward the side of the prism plate 402, specifically, the side of the light guiding member 405, and the output of the photo sensor 410 becomes large. In addition, in the state of C in FIG. 6, the position of the spot image of the illumination light shifts toward the side of the prism plate 401, specifically, the side of the light guiding member 404, and the output of the photo sensor 411 becomes large.

FIG. 7 illustrates the light detection outputs (vertical axis) of the photo sensors 410 and 411, which correspond to the states of A, B and C in FIG. 6. In FIG. 7, the output of the photo sensor 410 is illustrated by a circle mark, and the output of the photo sensor 411 is illustrated by a triangle mark. As is illustrated in FIG. 7, when the state in which the light is incident on the detecting unit 4 (light receiving unit) is the state of B in FIG. 6, the outputs of the photo sensors 410 and 411 are almost equal. On the other hand, when the incident state has changed to the state of A in FIG. 6, the output of the photo sensor 410 becomes larger than the output of the photo sensor 411. In addition, in the state of C in FIG. 6, the output of the photo sensor 411 becomes larger than the output of the photo sensor 410.

As has been described above, it is understood that the change of the shape such as the concave and convex on the surface of the object 2 can be detected through the output distribution of the photo sensors 410 and 411.

Then, the measurement arithmetic section 5 can perform, for instance, the following surface shape measurement processing.

As in the above description, the output distribution (large or small) of the photo sensors 410 and 411 may be treated as signals which correspond to the surface shape in the portion which is irradiated with a spot by the scan unit 1 at the measurement timing. Then, the measurement arithmetic section 5 processes digital data obtained by converting an analog signal which is the output of the photo sensors 410 and 411 obtained at certain measurement timing, to a digital signal, and thereby can evaluate the surface shape. In the following description, the outputs of the photo sensors 410 and 411 are referred to as IA and IB, respectively.

The measurement arithmetic section 5 can capture a large number of the outputs IA and IB of the photo sensors 410 and 411 during scanning of one line with the illumination by the scan unit 1, through clock synchronization with the scan unit 1. Then, the measurement arithmetic section 5 can calculate, for instance, a difference (IA−IB) between and a sum (IA+IB) of the outputs of the photo sensors 410 and 411, at certain measurement (clock synchronization) timing, in the measurement arithmetic for the surface shape.

For instance, the change of the surface shape during scanning of one line with the illumination by the scan unit 1 can be detected through a change of a ratio (IA−IB)/(IA+IB) between the sum of and the difference between the outputs of the above described photo sensors 410 and 411 during the line scan. It may be said that this arithmetic technique is one of techniques for evaluating the output distribution of the photo sensors 410 and 411.

Incidentally, the change of the surface characteristics, for instance, a change of a reflection ratio and granularity on the surface of the object (change of surface characteristics not due to change of shape) can be detected through the sum (IA+IB) of the outputs of the photo sensors 410 and 411. As has been described above, in the arithmetic of obtaining the ratio between the sum of and the difference between the outputs of the photo sensors 410 and 411, the sum (IA+IB) of the outputs is included in the denominator, and accordingly the output distribution (difference (IA−IB)) in the surface characteristics of a measured portion of the object 2 at the measurement timing can be calculated. In addition, in a simple arithmetic specification, the change of the surface shape during the line scan may be detected simply through the difference (IA−IB) or the ratio (IA:IB) between the outputs. However, in this simple arithmetic specification, the result may be affected by the change of the surface characteristics in the measured portion of the object 2.

In addition, if an object is calibrated with the use of a sample of which the shape, the size, the height and the like have been previously determined, data of the shape corresponding to an actual shape or a shape difference between the object and the sample can be also acquired from the distribution of the outputs IA and IB of the photo sensors 410 and 411.

When the measurement arithmetic is performed in the above described way by the measurement arithmetic section 5, the surface shape in the portion in which the reflected light has been reflected on the object 2 can be measured through the distribution of the outputs IA and IB of the photo sensors 410 and 411. Specifically, according to the present example, a fine surface shape of the object 2 can be surely optically measured according to the output distribution of each of the photo sensors, with an easy and inexpensive configuration using the plurality of light guiding members 404 and 405 and the photo sensors 410 and 411. In such a configuration that only one set of the light guiding member and the photo sensor on the end thereof is used, for instance, as in the above described PTL 1, a complicated arithmetic processing is needed for generating the surface shape data which corresponds to a plurality of lines scanned with the illumination light, from the outputs of the photo sensor. According to the present example, the measurement arithmetic section 5 can perform the surface shape measurement by line or over the plurality of lines, which is scanned with the illumination light, by the above described simple arithmetic, at a very small arithmetic cost.

### (Defect Determination)

It is also possible that the measurement arithmetic section 5 outputs its surface shape measurement result to the defect determining section 430 (FIG. 1), and the defect determining section 430 determines the defect of the object 2 according to the surface shape measurement result.

For instance, an unillustrated driving system rotationally drives the object 2 having the cylindrical shape very little by little, in synchronization with the line scan by the laser illumination light of the scan unit 1, and the surface shape measuring apparatus repeats surface shape measurement which will be described later, on each of the lines scanned with the illumination light. Thereby, the surface shape is measured over the whole perimeter of the object 2. At this time, the measurement arithmetic section 5 can calculate the ratio (IA−IB)/(IA+IB) between the sum of and the difference between the outputs of the photo sensors 410 and 411, as in the above description. This ratio (IA−IB)/(IA+IB) between the sum of and the difference between the outputs of the photo sensors 410 and 411 can be considered to be the surface shape data corresponding to the surface shape in the illuminated portion with the laser illumination light by the scan unit 1.

Then, the measurement arithmetic section 5 outputs the ratio (IA−IB)/(IA+IB) between the sum of and the difference between the outputs of the photo sensors 410 and 411 to the defect determining section 430, in synchronization with a clock which controls the spot scan of the scan unit 1, and the like. Thereby, for instance, the defect determining section 430 can evaluate the surface shape data corresponding to one scanning line by the laser illumination light of the scan unit 1, as a data column of the ratio (IA−IB)/(IA+IB) between the sum of and the difference between the outputs of each of the photo sensors at each of the scan timings, in synchronization with the spot scan.

The defect determining section 430 can determine whether the object 2 is good or poor, according to the evaluation result of this surface shape data. If the ratio (IA−IB)/(IA+IB) between the sum of and the difference between the outputs of the photo sensors 410 and 411 at the scan timing is a value within a fixed range, in one line scanned with the illumination by the scan unit 1, for instance, it is determined that (portion corresponding to scanning line) has no defect. In addition, if there exists one or a plurality of irregular portions in which the ratio (IA−IB)/(IA+IB) between the sum of and the difference between the outputs of the photo sensors 410 and 411 exceeds a threshold value that has been previously determined by sample measurement or the like, it is determined that (portion corresponding to scanning line) has a defect.

In addition, the defect determining section 430 can determine the defect also over a plurality of lines scanned with the illumination by the scan unit 1. As a result of the above described defect determination in which one line is used as a target, for instance, the scanning lines can be classified into a scanning line showing the defect or a scanning line showing no defect. After the whole perimeter of the object 2 has been scanned, for instance, if the scanning line with the defect has not been detected, it is determined that the object 2 has no defect. In addition, when one or a plurality of scanning lines having the defect have been detected, it is determined that the object 2 has the defect.

In addition, the defect can also be determined according to the following technique. Specifically, after the scan unit 1 has scanned the whole object 2 with the illumination, the defect determining section 430 determines the defect by: constructing two-dimensional data of the ratio between the sum of and the difference between the outputs of the photo sensors 410 and 410 (shape data), and the sum of the outputs (luminance data); regarding these shape data and luminance data as different image data one by one; and individually processing the images.

In addition, the defect may be determined with reference to the shape data, based on the image processing result of the luminance data, or with reference to the luminance data, based on the image processing result of the shape data.

In addition, the objects 2 can be classified into a non-defective product or a defective product according to the above described illustrated defect determination result of the defect determining section 430. The manufacture or conveyance line of the object 2 can be controlled according to the non-defective and defective determination result which has been obtained in the above described way. For instance, by controlling a conveying unit (not illustrated) such as a robot and a conveyor, the manufacture or conveyance line of the object 2 can be controlled so that when the object 2 to be inspected is a non-defective product, the object 2 is conveyed to the next step of processing the non-defective product, and when the object 2 is a defective product, the object 2 is conveyed to another next step of processing the defective product.

As has been described above, the measurement arithmetic section 5 outputs its surface shape measurement result to the defect determining section 430, and the defect determining section 430 can determine the defect of the object 2 or further can determine whether the object 2 is good or poor, according to the surface shape measurement result.

### Modification

In the above described surface shape measuring apparatus, one of conditions which determine a measurement limit of the change of the shape of the object 2 is a spot diameter of the illumination light which the scan unit 1 emits. Here, when a change of the shape has occurred that is larger than the spot diameter which the scan unit 1 emits, for instance, when a distance larger than the spot diameter or an irradiation position of the spot has been changed by the concave and convex of the object 2, the reflection light is incident on one side of the light guiding members 404 and 405 of the detecting unit 4. In the hardware configuration of the above described surface shape measuring apparatus, as for a change of the shape, which exceeds such a size that the spot image imaged by the image forming device 3 is incident on only one side of the light guiding members 404 and 405, the size cannot be distinguished. On the other hand, in order to catch the change of the shape in a wide range, it is necessary to increase the spot diameter to some extent beforehand, which is imaged on the vicinity of the light incident surface of the detecting unit 4 (light receiving unit). One of easy techniques for adjusting the imaging size of the spot diameter which is imaged on the vicinity of the light incident surface of the detecting unit 4 (light receiving unit) is a technique of changing a space arrangement of the image forming device 3 and the detecting unit 4 (or object 2). It is also considered, for instance, that an elevating mechanism for changing the position of the image forming device 3 very little by little is arranged so that the position can be finely adjusted at the site where the surface shape measuring apparatus is installed. Such a configuration can extremely easily adjust the sensitivity of surface shape measurement at the site where the surface shape measuring apparatus is installed.

However, if the spot diameter has been set to be extremely large, the sensitivity for the change of the position due to the change of the shape of the object 2 is lowered, and accordingly a small change of the shape of the object 2 becomes unable to be detected. The measurement range and the sensitivity may be determined by an experiment. When the light guiding member is used which has, for instance, a whole length of approximately several cm to several tens cm and a diameter of approximately 5 to 10 mm in a transverse direction, as has been described above, the imaging power of the image forming device 3 is set beforehand so that the diameter of the spot which the scan unit 1 emits is set in a range of 0.1 to 3 mm. In general, the imaging power of the image forming device 3 is set so as to become smaller than the size in a transverse direction of these light guiding members, on the vicinity of the light incident surface of the light guiding members 404 and 405.

In the configuration illustrated in FIG. 1 to FIG. 4, the photo sensors 410 and 411 are each arranged on only one of lateral surfaces of the light guiding members 404 and 405 of the detecting unit 4 (light receiving unit), and the reflecting plates 415 and 416 are each provided on the other lateral surface. However, the photo sensors 410 and 411 may be arranged on both of the lateral surfaces of the light guiding members 404 and 405. When the plurality of photo sensors are thus provided in one light guiding member, for instance, the sum of the outputs of each of the photo sensors is calculated and can be treated as an output from one light guiding member. According to such a configuration that the photo sensors are arranged on both of the lateral surfaces of the light guiding members 404 and 405, there is a possibility that information on the detection rays which are transmitted in the light guiding member can be more effectively utilized for the surface shape measurement.

In addition, the photo sensors 410 and 411 do not necessarily need to be provided so as to face the lateral surfaces of the light guiding members 404 and 405. For instance, it is acceptable to take out the detection rays from one or both of the lateral surfaces of the light guiding members 404 and 405, through the optical fiber or the like, and to make the detection rays be incident on the photo sensors 410 and 411 which are arranged on another appropriate position. According to the configuration thus using the optical fiber or the like, there is a possibility that the flexibility of the arrangement of the photo sensors 410 and 411 increases, and the surface shape measuring apparatus can be configured in a more compact apparatus contour.

Incidentally, in the above description, it is considered that the light guiding members 404 and 405 are formed of a resin material such as an acrylic having a square bar shape, but the material and the cross-sectional shape are not limited to the above described configurations as long as the light guiding members have such a configuration as to have the longitudinal direction (surface) and the transverse direction (surface). For instance, the cross-sectional shape does not necessarily need to be the rectangular shape illustrated in FIG. 3, and the light incident surface and the light emitting surface do not necessarily need to be flat surfaces. For instance, the light guiding members 404 and 405 can be configured with the use of such as a bundle fiber in which a plurality of optical fibers are bundled.

### Example 2

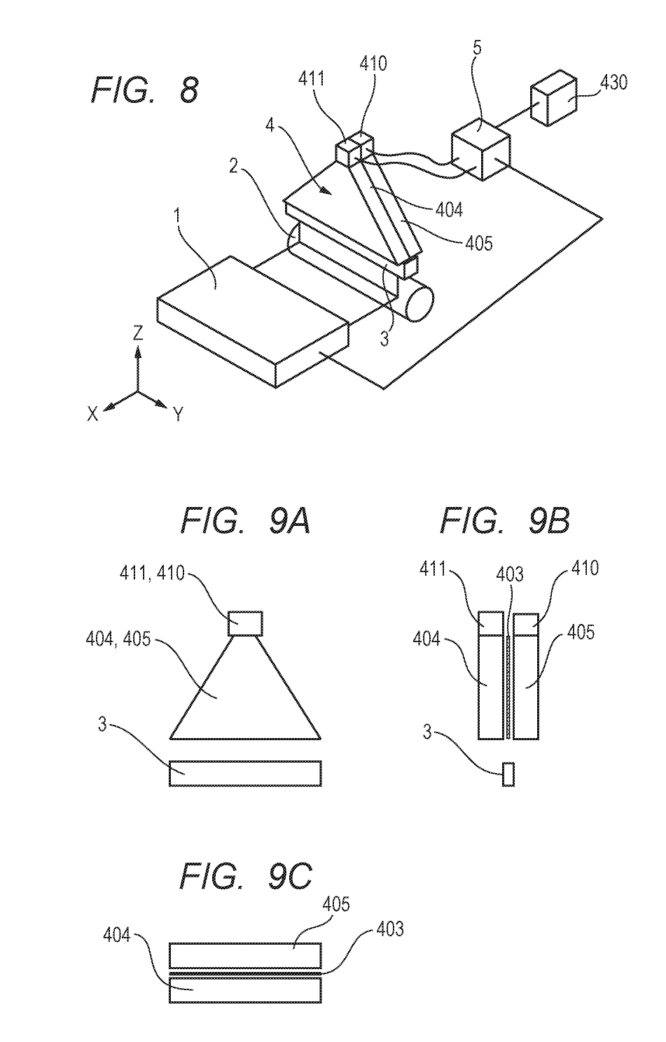

In the above described example, the portion at which the photo sensors 410 and 411 receive the detection rays is determined to be the lateral surfaces of the light guiding members 404 and 405 of the detecting unit 4 which constitutes the light receiving unit. However, the present invention is characterized in such a point that the longitudinal surface of the light guiding member of the light receiving unit (detecting unit 4) constitutes a light incident surface, and the portion at which the detection rays are received is not limited to the lateral surface of the light guiding member. The configuration example of a surface shape measuring apparatus will be shown below with reference to FIG. 8 to FIGS. 9A to 9C in which the portion at which the detection rays are received is arranged in a portion that is different from the lateral surface of the light guiding member.

FIG. 8 and FIGS. 9A to 9C illustrate one example of the configuration in which the light emitting surfaces of the light guiding members 404 and 405 are arranged on a side facing the longitudinal surfaces that constitute the light incident surfaces of these light guiding members, and the photo sensors 410 and 411 which receive the detection rays are arranged so as to face the light emitting surfaces. In addition, the configuration in FIG. 8 and FIGS. 9A to 9C is characterized also in such a point that the light guiding members 404 and 405 have different sizes between the light incident surface side and the light emitting surface side. FIG. 8 illustrates the configuration of the surface shape measuring apparatus (which includes defect determining section 430) in a similar form to that in FIG. 1. In addition, FIGS. 9A to 9C illustrate the configuration of the detecting unit 4 in FIG. 8, from each direction of X, Y and Z in FIG. 8. The members which are same as or equivalent to those in the above descried example are denoted by the same reference numerals below, and the detailed description shall be omitted.

The present example is different from the above described example only in the shape of the light guiding members 404 and 405, and in the arrangement of the light emitting surface and the photo sensors 410 and 411, and other configurations are similar to those in the above described example. In addition, modified examples similar to the above described examples can be applied to the details of the shape and the arrangement. For instance, in FIG. 8, the scan unit 1, the object 2, the image forming device 3, the measurement arithmetic section 5 and the defect determining section 430 are similar to those in the above described example.

In the present example, one of the longitudinal surfaces of the light guiding members 404 and 405 is determined to be the light incident surface, and is arranged along and in parallel to the object 2 and the image forming device 3, and the opposite side to the light incident surface is determined to be the light emitting surface. Generally, the size of the photo sensors 410 and 411 is as considerably small as an order of approximately several mm, compared to the above described object 2 having the whole length in the order of at least several cm and the light guiding members 404 and 405 having the whole length consistent with that of the object 2. Because of this, when an opposite side of the longitudinal surface (light incident surface) of the light guiding members 404 and 405 is determined to be a light emitting surface, as in the present example, the cross-sectional shape (along YZ plane) of the light guiding members 404 and 405 can be determined to be a trapezoidal shape, as is illustrated in FIG. 8 and FIG. 9A.

Specifically, the cross-sectional shape is determined to be such a shape that the light emitting surface side on which the photo sensors 410 and 411 are arranged becomes gradually smaller compared to the light incident side of the light guiding members 404 and 405, and the light emitting surface sides on which the photo sensors 410 and 411 are arranged so as to face the light emitting surfaces can be determined so as to have a size in the order of the size of the respective photo sensors. The light guiding members 404 and 405 having such a shape can be easily formed by integral molding of an acrylic resin or the like.

When the light guiding members 404 and 405 are configured to have the trapezoidal shape as illustrated in FIG. 8 and FIG. 9A, the light guiding members 404 and 405 can make the inside of each of the light guiding members totally reflect the reflection light which has been incident from the light incident surface (longitudinal surface of bottom surface) side of the light guiding members 404 and 405, and can gradually converge the totally reflected light toward the light emitting surface side. Accordingly, such a shape of the light guiding member can efficiently transmit the detection rays to the photo sensors 410 and 411.

Incidentally, all of the configurations arranged around the light guiding members 404 and 405 which have been described in the above described example are not illustrated, but the configurations can be set in an approximately similar way in the present example as well. For instance, in FIG. 9A and FIG. 9B, a light shielding plate 403 is illustrated which is arranged between the light guiding members 404 and 405. The light shielding plate 403 is a member which functions for preventing optical crosstalk between the light guiding members 404 and 405.

In addition, the reflecting plates 408 and 409 or 415 and 416 in the above described example can be arranged, for instance, on two inclined surfaces or an outer side face having the trapezoidal shape of each of the light guiding members 404 and 405, in the present example. In addition, the prism plates 401 and 402 in the above described example can be arranged on the light incident surface side of the bottom surfaces of the light guiding members 404 and 405, in the present example as well.

Incidentally, in the present example, when the above described light shielding plate, reflecting plates and prism plates are set, various modified examples of these plates shown in the above described example may be applied. In addition, in the present example, the opposite sides to the light incident surfaces of the light guiding members 404 and 405 are used as the light emitting surfaces, and accordingly the diffusing plates 406 and 407 in the above described example are not necessary.

The electrical functions of the photo sensors 410 and 411, the measurement arithmetic section 5 and the defect determining section 430 are similar to those in the above described example. The measurement arithmetic section can measure the surface shape of the object 2 through the distribution of the outputs of the photo sensors 410 and 411, and the defect determining section can determine the defect based on the result, similarly to the above description.

As has been described above, also in such a configuration that the light emitting surfaces of the light guiding members 404 and 405 are arranged on a side facing the longitudinal surface that constitutes the light incident surface of the light guiding member, as in the present example, the surface shape can be measured, or further the defect can be determined, based on the surface shape measurement result, in an approximately similar way to the above described example. In the present example, the whole height of the whole apparatus becomes high, but there is a possibility that the detection rays can be efficiently transmitted to the photo sensors 410 and 411 by the light guiding members 404 and 405 having the trapezoidal shape.

Incidentally, when the light emitting surfaces of the light guiding members 404 and 405 are arranged on sides facing the longitudinal surfaces that constitute the light incident surfaces of these light guiding members, there is a possibility that the transmission efficiency of the detection rays to the photo sensors 410 and 411 can be enhanced by selecting the shape of the light guiding members 404 and 405. For instance, the light guiding members 404 and 405 may be deformed into such an arbitrary shape that the emission side and the incidence side are different from each other in the size. A conceivable shape in this case is, for instance, not only the above described trapezoidal shape, but also a shape formed by finely correcting the trapezoidal shape or other different shapes. For instance, the light guiding member 404 and 405 have the trapezoidal shape of which the inclined surface that connects the incidence side and the emission side has a straight shape, but this inclined surface can be deformed into an arbitrary curved shape in consideration of the total reflection or the like, which occurs in the inside.

### Example 3

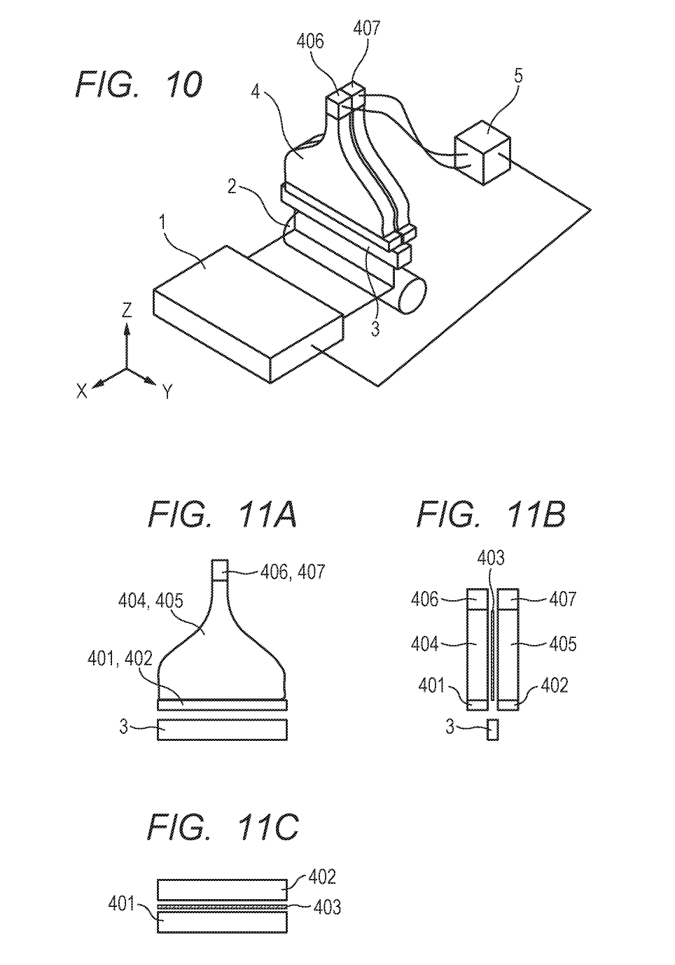

FIG. 10 illustrates a specific configuration of a surface shape measuring apparatus of Example 3. The surface shape measuring apparatus will be described below with reference to FIG. 10, but a coordinate system (X-Y-Z) illustrated in FIG. 10 is used for convenience.

In FIG. 10, the scan unit 1, the object 2 and a lens system 3 are the same units as those described in Example 1, and the effects are also the same. Light which has been emitted from the scan unit 1 is reflected on the object 2 at a predetermined angle (here, 90°), and is incident on the detecting unit 4 through the lens system 3.

In the above described Example 2 as well, the reflecting angle is set at 90°, but may be any angle as long as a photo detector is in a state of being capable of detecting the quantity of the reflected light. The “state of being capable of detecting quantity of reflected light” means a state in which photo detectors 406 and 407 can discriminate the light, compared to noises that are generated therein. When a signal of the photo detectors 406 and 407 is represented by S, and the noise is represented by N, the above described state is a state in which the ratio S/N is 1 or more.

The scan unit 1 may be any unit, as long as the unit uses a technique of forming punctiform illumination having such a size that the light can be regarded as a spot on the surface of the object 2, and giving a change of the position with time.

For instance, it is acceptable to make one LED emit light in an LED printer head, or make a plurality of LED light-emitting elements corresponding to a size which can be regarded as the same spot simultaneously emit light therein.

The reflected light from the object 2 and the light of the scan unit 1 have an angle of 90°, and are incident on the detecting unit 4 through the lens system 3. The lens system 3 uses a SELFOC lens (SELFOC is registered trademark of Nippon Sheet Glass Company, Ltd.) in the present invention. This lens is a lens in which miniature lenses that are gradient index lenses are linearly aligned. A cylindrical lens may be used in place of this lens.

The detecting unit 4 includes the optical members 401 and 402 having a positive power, the light guiding members 404 and 405, and the light shielding plate 403. An optical element having a positive power is arranged so that the focal position of a light beam which becomes perpendicular to the light incident surface of the light guiding member is in between the light incident surface and the light emitting port of each of the light guiding members.

FIG. 11A to FIG. 11C illustrate the state.

As is illustrated in FIG. 11B, the light shielding plate 403 exists in between the optical members 401 and 402 and in between the light guiding members 404 and 405, and shields the light which has been incident on the optical member 401 and the light guiding member 404 so as not to be incident on the optical member 402 and the light guiding member 405.

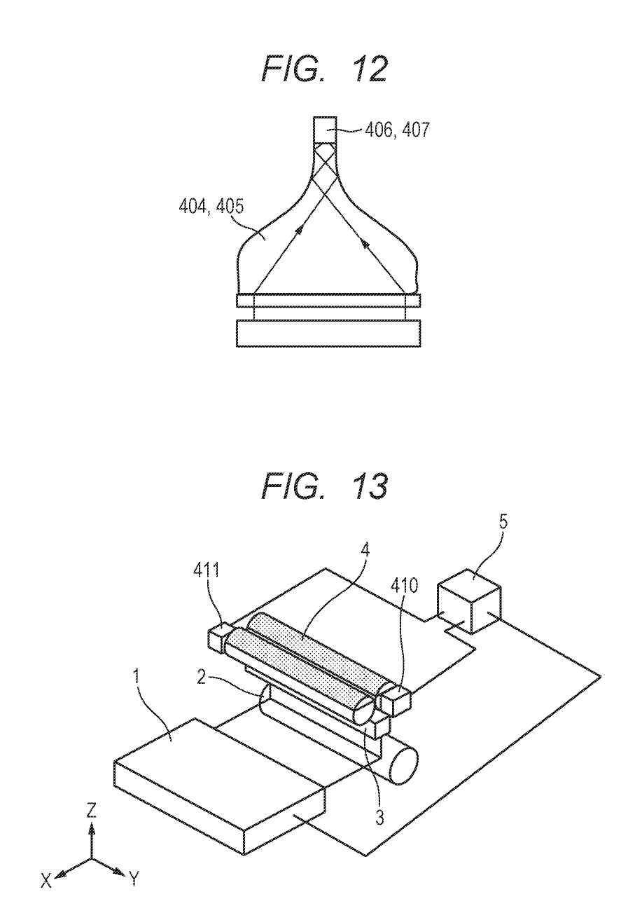

The reflected light from the object 2 passes through the optical members 401 and 402, and is incident on the light guiding members 404 and 405. The optical members 401 and 402 are Fresnel lenses having a positive power, in the present invention, and FIG. 12 illustrates a state of refraction of light which is reflected light from the object 2 and incident vertically on the optical members 401 and 402.

The vertically incident light is condensed on the ends of tapered shapes of the light guiding members 404 and 405, in other words, on the vicinity of drawn portions, due to the refractive power of the optical members 401 and 402.

The reflected light from the object 2 is light having an extent, and if the light condensing position of the vertically incident light is approached to the photo detectors 406 and 407, light other than the vertically incident light results in being emitted from the light guiding members 404 and 405 depending on the reflection which occurs in the drawn structure having the tapered shape. In other words, the shape of the light guiding member is the tapered shape, and is configured so that the light is emitted from an aperture portion which is a tapered end.

Because of this, the quantity of the light toward the photo detectors 406 and 407 results in decreasing. The optical members 401 and 402 are Fresnel lenses, but in the present invention, are manufactured so that each one Fresnel lens fits the light guiding members 404 and 405 symmetrically from the center which is regarded as a fiducial.

The light condensing positions of the optical members 401 and 402 are set in between the light incidence surface and the light emitting port so that the light can be efficiently incident on a portion in which the tapered shape changes to become thin.

As for the optical members 401 and 402, two optical members may be formed by cutting out one Fresnel lens. In addition, the power of the Fresnel lens is isotropic, but the optical member may be an optical member which has a power only in one direction, like a cylindrical Fresnel lens. At this time, the optical member is arranged so as to have the power in the longitudinal direction of the object 2. The luminous fluxes which have received the refractive action in the optical members 401 and 402 arrive at the photo detectors 406 and 407 while being totally reflected in the inside of the light guiding members 404 and 405.

Incidentally, the light guiding member 406 and 407 may be deformed so that a space is formed between the photo detectors 406 and 407. It is acceptable to bond the same material as that of the light guiding members 406 and 407 or a member having high optical transparency, to the light emitting ports of the light guiding members 406 and 407, and to form the space therebetween.

The side faces of the light guiding members 404 and 405 are free-form surfaces that have tapered shapes of which the photo detectors 406 and 407 sides become smaller than the light incident portions, as is illustrated in FIG. 11A. In the free-form surface, the curved surface shape is determined according to the light condensing positions of the optical members 401 and 402.

The side faces of the light guiding members 404 and 405 is in any of a state of being polished and a state of having metal vapor deposited thereon, in order that the light is totally reflected thereon.

In the present invention, the side face is the polished surface, but metal vapor may be deposited on a region of the side face, from which the light is easily emitted.

The reflected light from the object 2 is incident on a boundary portion on which the optical members 401 and 402 are combined and the light guiding members 404 and 405 are joined, with such a spot shape that the center exists on the boundary portion, as is illustrated in FIG. 11C.

The state is the same as a state B in FIG. 6 in Example 1.

The position of the reflected light varies among the states of A, B and C in FIG. 6 according to the change of the shape on the surface of the object 2, and thereby the quantities of the rays change which are incident on the optical members 401 and 402 and the light guiding members 404 and 405 that constitute the detecting unit 4 in FIG. 10.

The limit of the shape measurement of the object 2 is determined by the spot diameter, but Example 2 is also similar to Example 1.

When the change of the shape becomes larger than the spot diameter, the reflected light is incident on one side of the light guiding members 404 and 405, and accordingly the change larger than the spot diameter cannot be detected.

In order to catch the change of the shape in a wide range, the spot diameter needs to be increased. For this purpose, it is effective to change a space between the detecting unit 4 and the lens system 3.

However, if the spot diameter has been set to be extremely large, the sensitivity for the change of the position due to the change of the shape of the object 2 is lowered, and accordingly a small change of the shape of the object 2 becomes unable to be detected. A user may experimentally determine the measurement range and the sensitivity according to the application. In the present invention, the spot diameter is set in a range of 0.1 to 3 mm.

The rays which have been emitted from the light guiding members 404 and 405 are independently incident on the photo detectors 406 and 407, and are converted into electric signals. The outputs of the photo detectors 406 and 407 are converted from an analog output to a digital output by an A/D converter which is installed in the measurement arithmetic section 5, and the converted signal is accumulated in the measurement arithmetic section 5.

At this time, when the A/D converter is started, the output from the photo detector 105 is used.

The state of the spot of the reflected light from the object 2 becomes similar to the states of A, B and C, which are illustrated in FIG. 6.

The data which has been accumulated in the measurement arithmetic section 5 shows the rays which have passed through the optical members 401 and 402 and the light guiding members 404 and 405.

For instance, in the state A in FIG. 6, when the quantity of the light incident on the optical member 401 and the light guiding member 404 has increased, the optical member 402 and the light guiding member 405 decrease.

The relationship is reversed in the state C. In other words, the state of the spot position can be determined from the outputs of the photo detectors 406 and 407.

In Example 3, when the output of the photo detector 406 is represented by IA, and the output of the photo detector 407 is represented by IB, the states of A, B and C described in FIG. 6 are determined with the use of the difference (IA−IB). Actually, the shape is calculated with the use of a sum (IA+IB) and with the use of a ratio (IA−IB)/(IA+IB).

In addition, when it is intended to find the change which is not due to the change of the shape, for instance, the change of the surface state, the sum (IA+IB) is utilized.

### Example 4

FIG. 13 illustrates a configuration of Example 4. The configuration will be described below with reference to FIG. 13, but a coordinate system (X-Y-Z) illustrated in FIG. 13 is used for convenience. In FIG. 13, the scan unit 1, the object 2, and a lens system 3 are the same units as those described in Example 1, and the effects are also the same. Light which has been emitted from the scan unit 1 is reflected on the object 2 at 90°, and is incident on the detecting unit 4 through the lens system 3. In Example 4, the reflecting angle is set at 90°, but may be any angle as long as a photo detector is in a state of being capable of detecting the quantity of the reflected light. The “state of being capable of detecting quantity of reflected light” means a state in which photo detectors 410 and 411 can discriminate the light, compared to noises that are generated therein.

When a signal of the photo detectors 410 and 411 is represented by S, and the noise is represented by N, the above described state is a state in which the ratio S/N is 1 or more.

The scan unit 1 may be any unit, as long as the unit uses a technique of forming punctiform illumination having such a size that the light can be regarded as a spot on the surface of the object 2, and giving a change of the position with time.

For instance, it is acceptable to make one LED emit light in an LED printer head, or make a plurality of LED light-emitting elements corresponding to a size which can be regarded as the same spot simultaneously emit light therein.

The reflected light from the object 2 and the light of the scan unit 1 have an angle of 90°, and are incident on the detecting unit 4 through the lens system 3. The lens system 3 uses a SELFOC lens (SELFOC is registered trademark of Nippon Sheet Glass Company, Ltd.) in the present invention.

This lens is a lens in which miniature lenses that are gradient index lenses are linearly aligned.

A cylindrical lens may be used in place of this lens.

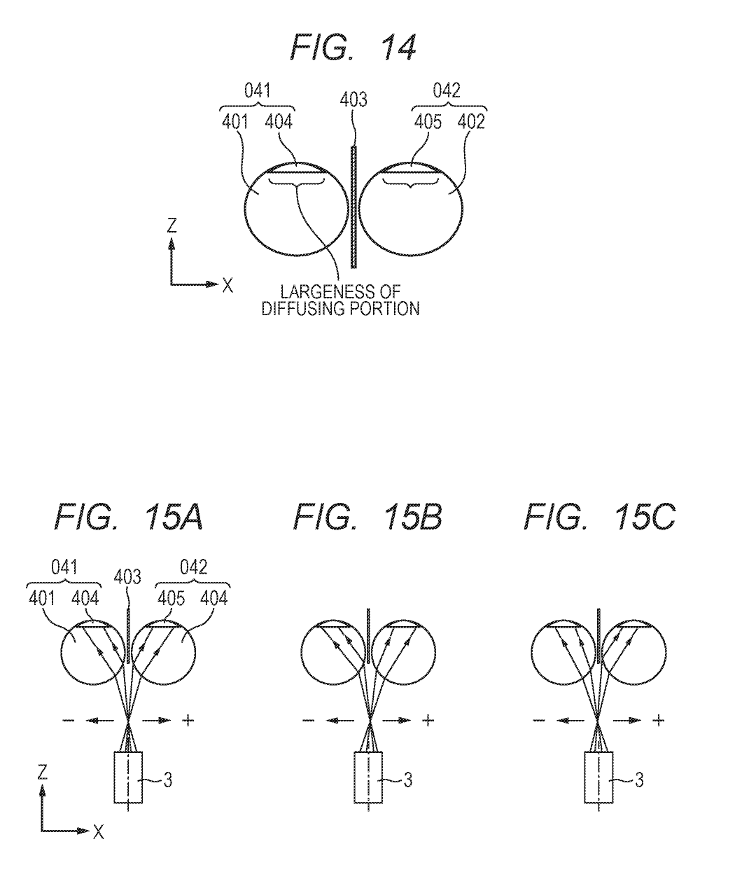

The detecting unit 4 includes light guiding members 041 and 042, and the light shielding plate 403. FIG. 14 illustrates the state.

As is illustrated in FIG. 14, the light shielding plate 403 exists in between the light guiding members 041 and 042, and shields the light which has been incident on the light guiding member 041 so as not to be incident on the light guiding member 042. The light guiding member 041 and the light guiding member 042 have the same configuration. The light guiding member 041 is a cylindrical body which is structured of a transparent member 401 and a diffusing portion 404, as is illustrated in FIG. 14. The material of the transparent member 401 is acrylic in the present invention. The light guiding member 041 becomes an aperture portion, except for the diffusing portion 404. The reflected light from the object 2 are incident on the light guiding members 042 and 041 from the cylindrical surface which is the side face, through the lens system 3. The diffusing portions 404 and 405 of the light guiding members 041 and 042 are arranged so as to be vertical to the optical axis of the lens system 3.

The diffusing portions 404 and 405 of the light guiding members 041 and 042 may form angles with respect to the optical axis, according to the sizes of the light guiding members 041 and 042, and the state of the reflected light from the object 2. In the present invention, the luminous fluxes to be incident on the light guiding members 041 and 042 are configured so as not to be vertically incident on the diffusing portions 404 and 405.

The reflected light from the object 2 are incident on the transparent members 401 and 402 while regarding a boundary portion 403 which combines the light guiding members 041 and 042 as the center, as is illustrated in FIGS. 15A to 15C. The light beams which have been incident from the side faces of the transparent members 401 and 402 are reflected and refracted. The refracted light reaches the diffusing portion 404 or 405. The light which has been incident on the diffusing portions 404 and 405 diffuses therein, and propagates in the inside of the transparent members 401 and 402 in a longitudinal direction (Y-direction in FIG. 13) of the cylindrical portion.

There are also rays which are reflected on the surfaces of the transparent members 401 and 402, and the reflected lights result in being incident on other surfaces.

The largeness of the diffusing portion in FIGS. 15A to 15C is determined according to the change of the light condensing position which is formed by the lens system 3, in other words, according to the measurement range. In the present invention, the light shielding plate 403 is provided between the light guiding members 041 and 042, and the position of the light shielding plate 403 is adjusted so that the light reflected on the surface of the transparent members 401 and 402 is not incident on the other side.

Among the rays which have diffused in the diffusing portions 404 and 405, there are rays which have been totally reflected in the insides of the transparent members 401 and 402, and have reached the photo detectors 410 and 411 that are attached to the ends of the light guiding members 041 and 042. The photo detectors 410 and 411 photoelectrically convert the rays into electric signals.

The outputs of the photo detectors 410 and 411 are converted from an analog output into a digital output by an A/D converter which is installed in the measurement arithmetic section 5, and the converted output is accumulated in the measurement arithmetic section 5. At this time, the A/D converter is started by using the output from the photo detector 105.

In the present example, the photo detectors 410 and 411 are attached to one side of each of the light guiding members 041 and 042, but the photo detectors may be attached to both sides.

When the photo detectors are attached to both sides, it is acceptable to bend the ends of the light guiding members 041 and 042, or to bond an arcuate acrylic rod to form a space between the photo detectors, in order to arrange the photo detectors.

In addition, a trapezoidal-shaped acrylic rod may be bonded so as to have a different size from the outer diameters of the light guiding members 041 and 042. When the photo detectors 410 and 411 are attached only to one side of the light guiding members 041 and 042, a reflector such as a mirror may be arranged in a portion to which the photo detector is not attached.

A device which is equivalent to the prism plate in Example 1 may be arranged on the incidence side of the light guiding members 041 and 042.

When the prism plate is arranged, the position of the light shielding plate 403 is adjusted, or the roughened surface of the prism plate is coated with black coating so that the light beam to be incident on the light guiding member 041 is not incident on the light guiding member 042.

FIGS. 15A to 15C illustrate the light guiding members 041 and 042, and the lens system 3.

FIG. 15A illustrates a state in which the light condensing position of the lens system 3 is an extension of the light shielding plate 403.

FIG. 15B illustrates a state in which the light condensing position of the lens system 3 is shifted to a plus side in an X-direction; and FIG. 15C illustrates a state in which the light condensing position of the lens system 3 is shifted to a minus side in the X-direction.

The change of the light condensing position of the lens system 3 is the change of the shape of the object 2, and FIGS. 15A to 15C illustrate the changes of the quantities of the rays which are incident on the light guiding members 041 and 042.

In FIGS. 15A to 15C, the refractive action on the cylindrical surface and the largeness of the diffusing portion 404 are associated with the characteristics of the changes of the quantities of the rays of the photo detectors 410 and 411, which is different from the detecting unit drawn in FIG. 6 that illustrates the configuration of Example 1. Because of this character, a distance between the lens system 3 and the light guiding members 041 and 042 is determined by an experiment.

When the output of the photo detector 410 is represented by IA, and the output of the photo detector 411 is represented by IB, the states of A, B and C described in FIGS. 15A to 15C are determined with the use of the difference (IA−IB). Practically, the shape is calculated with the use of the sum (IA+IB) and the ratio (IA−IB)/(IA+IB).

In addition, when it is intended to find the change which is not due to the change of the shape, for instance, the change of the surface state, the sum (IA+IB) is utilized.

### Example 5

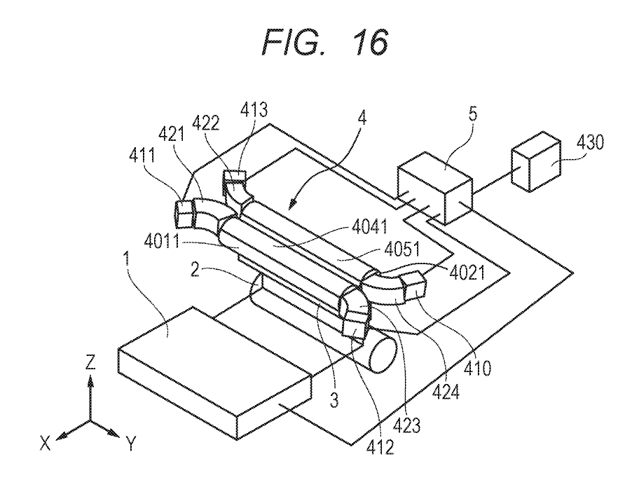

FIG. 16 illustrates an example of another configuration including the detecting unit 4 to the photo sensors. Members in the Example 5, which are the same as or corresponding to those described in the above Examples, are denoted by the same reference numerals. Detailed explanations of the same or corresponding members are omitted. And, detailed explanation as to the measuring control and the defect determining using the measurement arithmetic section 5 and the defect determining section 430 already described in the above Examples are omitted for eliminating redundancy by cumulative explanation.

In the above Examples 1 to 4, the sensors 410 and 411 are mounted on an end at only one side of the light guiding members (404, 405, 4011, 4021 and etc.). In contrast to those, this Example shows a structure suitable for mounting sensors 410 and 413 and sensors 411 and 412 on ends at both sides of the two light guiding members of the detecting unit 4.

As the detecting unit 4 according to this Example, the basic configuration shown in FIG. 1 (Example 1), FIG. 8 (Example 2), FIG. 13 (Example 4) and etc. may be used. In this Example, the detecting unit 4 shown in FIG. 1 (Example 1), FIG. 8 (Example 2) and FIG. 13 (Example 4) should have a structure for transmitting detection rays through the two light guiding members in a longitudinal direction and for emitting the detection rays from ends thereof.

The detecting unit 4 shown in FIG. 16 may be, in one example, the detecting unit 4 shown in FIG. 13 (Example 4). That is, the detecting unit 4 shown in FIG. 16 may comprise light guiding portions including the light guiding member 4011, a diffusing portion 4041, the light guiding member 4021 and a diffusing portion 4051 respectively formed in cylindrical shapes. Of course, the detecting unit 4 shown in FIG. 16 may be replaced with one shown in FIG. 1(Example 1) or FIG. 8 (Example 2).

According to this Example, as shown in FIG. 16, the photo sensors 411 and 412 and the photo sensors 410 and 413 are mounted on both sides of the light guiding member 4011 and the light guiding member 4021. That is, the two photosensors are mounted on both side of the one light guiding member, to transmit output thereof to the measurement arithmetic section 5.

By means of that, detecting quantity of light or photo detected signal derived from the one light guiding member can be increased into double approximately. That is, amount of information based on the photo detection utilized by the measurement arithmetic section 5 can be increased into double. Thereby, for example, a performance as to a measuring accuracy and a measuring limit can be improved.

The measurement arithmetic section 5 adds (or averages) output signals from the photo sensors 411 and 412 or, the photo sensors 410 and 413, to derive information corresponding to the outputs (IA and IB) from the photo sensors 410 and 411. The measuring the surface shape and the defect determination through an arithmetic operation of the outputs (information corresponding to IA and IB) from the photo sensors 410 and 411 by means of the measurement arithmetic section 5 or the defect determining section 430 are the same as those described in the above Examples.

Considering a measurement condition such as a radius of the object 2 and a necessary detection accuracy range, there would be large number of cases wherein a distance between the light guiding members 4011 and 4021 (404, 405) shown in FIG. 16 cannot be made longer.

Therein, for an example, in case of the detecting unit 4 shown in FIG. 1 (Example 1), FIG. 8 (Example 2), FIG. 13 (Example 4), it is considered to contact the photo sensors closely to the both ends of the light guiding members 4011 and 4021 (404, 405). In this case, there would be raised a problem of cross-talk between the two photo sensors arranged at the same end side of the two light guiding members. For example, a detection light or ray leaked from an end of one of the two light guiding members possibly be incident into the other of the two light guiding members adjacent to each other. In such case, necessarily, an error would be caused in the measuring the surface shape and the defect determination.

Accordingly, in FIG. 16, between each of both ends of the light guiding members 4011 and 4021 and each of four photo sensors 410 to 413, curved light guiding members 421, 422, 423 and 424 are arranged. The curved light guiding members 421, 422, 423 and 424 are formulated in a shape of curving the light guiding member of square bar into an arc shape. For example, the members may be formulated integrally from light guiding material such as acrylic or glass material.

Cross-section shapes of the light guiding members 421, 422, 423 and 424 may be circular or ellipse shape. And, a purpose of curving the shape of the light guiding members is to separate the photo sensors 410 and 412 from each other and to separate the photo sensors 411 and 413 from each other, respectively at the same sides of the light guiding members 4011 and 4021 as shown in FIG. 16, to increase a distance therebetween. Accordingly, the shape of the light guiding members 421, 422, 423 and 424 may be any curved shape deduced by those skilled in the art even though the shape is not circular as shown in FIG. 16, on the condition that the shape degrades internal light transmission efficiency significantly.

By means of the structure shown in FIG. 16, it can be prevented to incident the light leaked from the one of the light guiding members 4011 and 4021, erroneously onto the photo sensor of the other of the light guiding members 4011 and 4021.

And, the light guiding members 421, 422, 423 and 424 in FIG. 16 are curved, to separate the photo sensors 410 and 412 at the same side from each other and to separate the photo sensors 411 and 413 at the same side from each other. Moreover, optical axes of light emitted from the light guiding members 421 and 422 are not parallel, so as not to be crossed (turn to opposite direction) to each other in an external space. Also, optical axes of light emitted from the light guiding members 423 and 424 are not parallel, so as not to be crossed (turn to opposite direction) to each other in an external space.

Accordingly, even in case that the light is leaked from the end of those light guiding members, the optical cross-talk between the sensors 410 and 412 or 411 and 413 at the same end side can be reduced significantly.

And, the light guiding members 421 to 424 may be fixed, through a bonding, between each of the both ends of the light guiding members 4011 and 4021 and each of photo sensors 410 to 413. Side surfaces of those light guiding members 421 to 424 except for light incident surfaces and the light emitting surfaces may be formed into reflecting surface by a metal vapor deposition. Thereby, light leakage from the surface except for light incident surfaces and the light emitting surfaces of the light guiding members 421 to 424 can be prevented, to improve the light transmission efficiency to each of the photo sensor.

The light guiding members 421 to 424 may be formed from components formed separately from the light guiding members 4011 and 4021, and even may be components formed integrally with the light guiding members 4011 and 4021. For example, the light guiding members 4011 and 4021 may be integrally from light guiding material such as acrylic or glass material, to have total lengths longer than those shown in FIG. 16, and may have both ends of curved shape equal to the shape of the light guiding members 421 to 424.

By means of the above structure, also in the Example 5, the advantageous operation and effect equal to those obtained in the Examples 1 to 4 can be provided. In particular, the Example 5 has a structure such that, since the lights are received at both ends of the light guiding members 4011 and 4021, the sensors 410 and 412 or 411 and 413 are arranged adjacently at the same side of the light guiding members 4011 and 4021. According to the Example 5, for each of the sensors 410 and 412 or 411 and 413 arranged adjacently at the same side of the light guiding members 4011 and 4021, the light guiding members 421 to 424 are arranged.

The light guiding members 421 and 422 (or 423 and 424) have shapes to guide the lights so that the optical axes of the detection rays emitted from each of light guiding members 421 and 422 do not cross to each other outside of the light guiding members. By means of using the light guiding members 421 to 424, reflected light is guided to each of the sensors 410 to 413, to prevent the cross-talk between the sensors 410 and 412 or 411 and 413.

Accordingly, without any adverse effect due to an optical cross-talk between detection rays received through the different light guiding members 4011 and 4021, the measurement arithmetic section 5 and the defect determining section 430 are used to achieve a high accuracy and a high reliability in the measuring the surface shape and the defect determination.

And, by means of the above structure according to this Example, the sensors 411 and 412 or 410 and 413 are arranged at both ends of the light guiding member 4011 or 4021, to receive the detection rays from one of the light guiding member 4011 and 4021 by the two sensors 411 and 412 or 410 and 413. Accordingly, though a processing of adding (or averaging) the outputs from the sensors 410 and 413 or 411 and 412, the measurement arithmetic section 5 and the defect determining section 430 are used to achieve a high accuracy and a high reliability in the measuring the surface shape and the defect determination.

### ADVANTAGEOUS EFFECTS OF INVENTION

According to the above described configuration, a surface shape of the object can be measured with such an easy and inexpensive configuration that photo sensors are arranged on respective light emitting surfaces of a plurality of light guiding members which are adjacently arranged so that the longitudinal surface (light incident surface) is arranged along the longitudinal direction of the object. Alternatively, furthermore, a defect of the object can be measured with the use of this surface shape measurement result.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-254579, filed Dec. 16, 2014, and Japanese Patent Application No. 2015-236519, filed Dec. 3, 2015, which are hereby incorporated by reference herein in their entirety.

1. A surface shape measuring apparatus which illuminates an object and measures a shape of the object through an output of a photo sensor that receives reflected light that has been reflected on a surface of the object, comprising:
a light receiving unit having:
two light guiding members which are adjacently arranged so that longitudinal surfaces thereof are arranged along the surface of the object, and
photo sensors that receive rays which are incident to the light guiding members,
wherein the surface shape measuring apparatus is configured to measure a surface shape of the object, based on at least one of a sum of values of outputs of photo sensors, a difference between the values of the outputs of the photo sensors and a ratio among the values of the outputs of the photo sensors.

2. The surface shape measuring apparatus according to claim 1, further comprising an illumination light scanning unit, wherein the reflected light is reflected light of illumination light with which the illumination light scanning unit has scanned a surface to be measured of the object in the longitudinal direction.

3. The surface shape measuring apparatus according to claim 1, wherein a light shielding member is arranged in between adjacently arranged light guiding members of the light receiving unit.

4. The surface shape measuring apparatus according to claim 1, wherein an optical member having a prism structure is arranged on a light incident surface of the light receiving unit.

5. The surface shape measuring apparatus according to claim 4, wherein an optical member having light diffusion characteristics is arranged on an interface which faces the light incident surface of the light receiving unit.

6. The surface shape measuring apparatus according to claim 4, wherein optical members having light reflection characteristics are arranged on interfaces except the light incident surface of the light receiving unit, an opposite surface to a light incident surface of light guiding member, and a light emitting surface of the light guiding member on which the photo sensor is arranged.

7. The surface shape measuring apparatus according to claim 4, wherein the light guiding member has such a size that the longitudinal surface that constitutes the light incident surface of the light receiving unit is spaced from an opposite surface of the longitudinal surface, at a distance of at least 5 mm or more.

8. The surface shape measuring apparatus according to claim 1, wherein the light guiding member is formed from a material having high optical transparency.

9. The surface shape measuring apparatus according to claim 4, further including a microlens array.

10. The surface shape measuring apparatus according to claim 4, further including an image forming device which includes a cylindrical lens which has an optical surface that is cylindrical and approximately parallel to the light incident surface of the light receiving unit.

11. The surface shape measuring apparatus according to claim 9, wherein an imaging power of the microlens array is set so that an imaging size of the reflected light, which is imaged by the microlens array, becomes smaller than a size in a transverse direction of the light guiding member, on a vicinity of the light incident surface of the light guiding member.

12. The surface shape measuring apparatus according to claim 4, wherein the light emitting surface of the light guiding member is a lateral surface of the light guiding member, and the photo sensor is arranged so as to receive the reflected light which is emitted from the lateral surface.

13. The surface shape measuring apparatus according to claim 4, wherein the light emitting surface of the light guiding member is arranged on a side which faces the longitudinal surface that constitutes the light incident surface of each of the light guiding members, and the photo sensor is arranged so as to receive the reflected light which is emitted from the light emitting surface.

14. The surface shape measuring apparatus according to claim 13, wherein the light guiding member has different sizes between a light incident surface side and a light emitting surface side.

15. The surface shape measuring apparatus according to claim 4, wherein an optical element having a positive power is arranged so that a focal position of a light beam which becomes perpendicular to the light incident surface of the light guiding member is in between the light incident surface and a light emitting port of the light guiding member.

16. The surface shape measuring apparatus according to claim 15, wherein a shape of the light guiding member is a tapered shape, and is configured so that light is emitted from an aperture portion which is a tapered end.

17. The surface shape measuring apparatus according to claim 15, wherein the optical element is a Fresnel lens.

18. The surface shape measuring apparatus according to claim 1, wherein
the light guiding member is an optically transparent cylindrical member which has a diffusing portion.

19. The surface shape measuring apparatus according to claim 18, wherein the light guiding member is configured so that light is incident from a side face, and the light is emitted from an arcuate member which is attached to an end face and has optical transparency.

20. A defect determining apparatus comprising: a defect determining section that determines a defect of an object according to a surface shape of the object, which has been measured by a surface shape measuring apparatus which illuminates an object and measures a shape of the object through an output of a photo sensor that receives reflected light that has been reflected on a surface of the object, the surface shape measuring apparatus comprising:
a light receiving unit having:
two light guiding members which are adjacently arranged so that longitudinal surfaces thereof are arranged along the surface of the object, and
photo sensors that receive rays which are incident to the light guiding members,
wherein the surface shape measuring apparatus is configured to measure a surface shape of the object, based on at least one of a sum of values of outputs of photo sensors, a difference between the values of the outputs of the photo sensors and a ratio among the values of the outputs of the photo sensors.
